(19) United States
(12) Patent Application Publication
(10) Pub. No.: US 2017/0184477 A1
(43) Pub. Date: Jun. 29, 2017

(54) COMPOSITIONS, METHODS, AND SYSTEMS FOR TISSUE FIXATION

(71) Applicant: Ventana Medical Systems, Inc., Tucson, AZ (US)

(72) Inventors: Daniel Bauer, Tucson, AZ (US); David Chafin, Tucson, AZ (US); Michael Otter, Tucson, AZ (US); Abbey Pierson Theiss, Tucson, AZ (US)

(21) Appl. No.: 15/456,260

(22) Filed: Mar. 10, 2017

Related U.S. Application Data
(63) Continuation of application No. PCT/EP2015/070927, filed on Sep. 14, 2015.
(60) Provisional application No. 62/051,737, filed on Sep. 17, 2014.

(51) Int. Cl. G01N 1/30; G01N 1/36

(52) U.S. Cl. CPC G01N 1/30; G01N 1/36; G01N 2001/305

(57) ABSTRACT

The present disclosure relates to use of high-concentration aldehyde-based fixatives to fix tissue samples. Aldehyde concentrations are selected that significantly increase rate of diffusion of the fixative solution into the tissue. When combined in the cold-temperature step of a two-temperature fixation, a substantial improvement in the preservation of post-translationally modified proteins is achieved.

### CROSS-REFERENCE TO RELATED APPLICATIONS

This is a continuation of International Patent Application No. PCT/EP2015/070927 filed Sep. 14, 2015, which claims priority to and the benefit of U.S. Provisional Application No. 62/051,737, filed on Sep. 17, 2014, both of which patent applications are incorporated herein by reference as if set forth in their entirety.

### BACKGROUND

Field of the Invention

The present disclosure relates to tissue fixation using aldehyde-based tissue fixatives.

Description of Related Art

Aldehyde-based fixatives are used almost ubiquitously in anatomic pathology laboratories. These solutions are favored because they are easy to use and because they do an excellent job of preserving tissue morphology. However, standard techniques using aldehyde-based fixatives often fail to preserve the molecular details of the tissue. In particular, residual enzyme activity during the fixation process can alter the pattern of post-translational modifications found in the cells. This presents a problem, because post-translational modifications have become important biomarkers for cancer diagnosis and prognosis and for predicting treatment efficacy. See Krueger and Srivastava, Posttranslational Protein Modifications: Current Implications for Cancer Detection, Prevention, and Therapeutics, Molecular & Cellular Proteomics, Vol. 5, Issue 10, p. 1799-810 (2006 Jul. 14). It therefore would be beneficial to develop reagents and processes for fixing cells using aldehyde-based fixatives that can preserve post-translational modifications during the fixation process.

In WO 2008-073187 A2, this problem is addressed by inhibiting endogenous kinase and phosphatase pathways by fixing the tissues in the presence of at least one kinase inhibitor and at least one phosphatase inhibitor and, optionally, at least one protease inhibitor. Similarly, in WO 2011-130280 A1, exogenous “degradation inhibitors” (such as protease and nuclease inhibitors) are used to prevent loss of potential analytes during fixation. However, direct inhibition of naturally occurring pathways in the tissue can affect the end results. For example, WO 2008-073187 A2 teaches that treatment of tissues with phosphatase inhibitors can cause “highly abnormal upward accumulation of abnormal levels of phosphoproteins.” These methods thus do not yield reliable results. Moreover, the amounts of inhibitors necessary to adequately block enzyme activity make the methods cost-prohibitive to implement on a wide scale.

Others have developed fast-freezing methods in order to halt the action of modification enzymes (Lawson et. al. Cytotoxicity effects of cryoprotectants as single-component and cocktail vitrification solutions, 2011, vol. 62, issue 2, pages 115-122). Although fast freezing may initially slow down the action of such enzymes, it does not completely inhibit their action upon thawing of the sample and thus is not an adequate solution for preserving post-translational modifications.

### SUMMARY

The present disclosure relates generally to the use of fixative solutions containing high concentrations of aldehyde to fix samples containing intact cells. In an embodiment, the aldehyde is present at higher-than-standard concentrations. In an embodiment, the high-concentration aldehyde-based fixative solution has an aldehyde concentration and pH sufficient to obtain a reduced time of diffusion to reach decay constant of at least 22% and up to 275% at a temperature of 2° C. to 8° C. In an embodiment, the high-concentration aldehyde-based fixative solution has an aldehyde concentration at least 1.25-times higher than the highest concentration of the aldehyde used in standard immunohistochemical fixation of the tissue. In an embodiment, the high-concentration aldehyde-based fixative solution comprises one or more buffers and has a pH in the range of 6 to 8. In an embodiment, the one or more buffers are selected from Table 1. In an embodiment, the high-concentration aldehyde-based fixative solution does not contain an effective amount of exogenously added nuclease inhibitor, phosphatase inhibitor, kinase inhibitor, or protease inhibitor. In an embodiment, the high-concentration aldehyde-based fixative solution is selected from the group consisting of greater than 20% formalin, such as, for example, greater than 25% formalin, at least about 30% to 50% formalin, or from about 30% to about 40% formalin. In an embodiment, the high-concentration aldehyde-based fixative solution consists of at least about 30% formalin, optionally one or more buffers and acid or base to adjust pH to a desired level, optionally one or more stabilizers, and optionally one or more inorganic salts.

A composition is also provided comprising a cell or tissue sample immersed in a high-concentration aldehyde-based fixative solution as disclosed herein.

A method of fixing a tissue sample is also provided, the method comprising immersing the tissue sample in a high-concentration aldehyde fixative solution as disclosed herein for a period of time sufficient to fix the tissue. In an embodiment, the tissue sample is immersed in the high-concentration aldehyde fixative solution at a low temperature to allow the solution to diffuse into the tissue sample and then the temperature is raised for a period of time sufficient to fix the tissue, wherein post-translation modification signals of said tissue sample are preserved. In an embodiment: (a) the tissue sample is immersed in the high-concentration aldehyde fixative solution at a temperature within the range of about −20° C. to about 15° C. for a first time period sufficient to diffuse the solution into the tissue sample; and (b) the tissue sample is immersed in a standard aldehyde fixative solution at a second temperature within the range of about 22° C. to about 50° C. for a second time period sufficient to preserve post-translation modification signal of said tissue sample.

A fixed tissue sample is also provided, wherein said fixed tissue sample was fixed according to any of the methods described herein. In an embodiment, the fixed tissue sample is embedded in paraffin. In an embodiment, the fixed tissue sample is a formalin fixed paraffin embedded tissue sample (FFPE sample).

A method of detecting a protein containing a post-translational modification in a fixed tissue sample is also provided, the method comprising: (a) contacting a fixed tissue sample as disclosed herein with an analyte-binding entity capable of specifically binding to the post-translationally modified protein under conditions sufficient to effect binding of the analyte-binding entity to the post-translationally modified protein; and (b) detecting binding of the analyte-binding entity to the post-translationally modified protein in the fixed tissue sample. In an embodiment, post-translational modification is one that is subject to loss during the fixation process due to residual enzyme activity within the tissue sample. In an embodiment, the post-translational modification is a diagnostic or prognostic marker for a disease state of the tissue sample. In an embodiment, the post-translational modification is a predictive marker for an effect of a therapy on a disease state of the tissue. In an embodiment, the post-translational modification is a phosphorylation.

### BRIEF DESCRIPTION OF THE DRAWINGS

FIG. 1: Bar graph showing H-score of colorectal carcinomas stained with anti-phospho-Akt. “Biop4C_10%” and “Spec4C_10%”: samples fixed with 10% NBF using a two temperature (4° C./45° C.) fixation protocol. “BiopRT_10%” and “SpecRT_10%”: samples fixed with 10% NBF using 24 hour room temperature fixation. “Biop4C_30%” and “Biop4C_30%”: samples fixed with 30% NBF during the 4° C. pre-treatment of the two temperature (4° C./45° C.) fixation protocol.

FIG. 2: Bar graph showing rate of diffusion in various tissues using 10% NBF versus 30% NBF. A. Comparison of the decay constants between 10% NBF and 30% NBF. As can be seen, 30% NBF consistently demonstrates a lower decay constant than 10% NBF, indicating that increased formalin concentration correlates with increased rate of diffusion across all tissue types tested. B. Demonstration of the diffusion speed gain using 30% NBF versus 10% NBF.

FIG. 3: Rows A1 and A2 illustrate 6 mm Calu-3 xenografts stained for phospho-Akt after a 2 hour 4° C. pre-treatment fixation with 10% NBF, 20% NBF, or 20% NBF+phosphatase inhibitor cocktail and a 2 hour 45° C. fixation using 10% NBF. Row B1 illustrates human tonsil samples cut to 4 mm thickness and stained with anti-phospho Bcl2 after fixation under the same two-temperature fixation using 10% NBF, 20% NBF, 30% NBF, or 40% NBF in the cold temperature step, with a 24 hour room temperature fixation in 10% NBF as a control. Row B2 illustrates human tonsil samples cut to 4 mm thickness and stained with anti-phospho-PTEN after fixation under a two-temperature fixation using 10% NBF, 20% NBF, 30% NBF, or 40% NBF in the cold temperature step, with a 24 hour room temperature fixation in 10% NBF as a control.

FIG. 4: 6 mm Calu3 xenograft tumors stained with anti-phospho-Akt after fixation under a two-temperature fixation using an initial 4° C. treatment in 10%, 20%, 30%, or 40% NBF for 2 hours, followed by a 2 hour treatment in 10% NBF at 45° C. for 2 hours to initiate crosslinking. An additional larger sample (piece) was similarly fixed using an initial 4° C. treatment in 40% NBF. An additional sample was placed into room temperature (RT) 10% NBF for 24 hours as a control.

FIG. 5: 6 mm core samples of Calu3 xenografts stained with anti-phospho-Akt after fixation under a two-temperature fixation using an initial cold temperature treatment with 30% NBF for 22 hours, followed by a high temperature treatment with 10% NBF for indicated times (5-120 minutes).

FIG. 6: Scoring of H&E-stained tissue fixed using a two-temperature fixation procedure. The top graph is data for a protocol using 30% NBF in an initial 4° C. pre-treatment for the indicated period of time (left axis), followed by a 45° C. treatment in 10% NBF for the indicated period of time (top axis). Darkest box indicates samples were of poor quality (upper left, 30/30 sample). Light boxes indicate samples were of moderate quality. Gray boxes indicate samples were of high quality (see bottom row right boxes). Bottom graph indicates an experiment identical to the above example but 4° C. pre-treatment was performed with 40% NBF.

FIG. 7: A. H&E stained skin, tonsil, kidney, and colon tissue fixed using a two hour cold treatment in 30% NBF followed by a two hour hot treatment in 10% NBF. B. H&E stained skin, tonsil, kidney, and colon tissue fixed using a standard 24 hour immersion in room temperature 10% NBF.

FIG. 8: A. H&E stained colon tissue fixed using a 6 hour cold treatment in 30% NBF followed by a 1 hour hot treatment in 10% NBF. B. H&E stained colon tissue fixed using a standard 24 hour immersion in room temperature 10% NBF. C. H&E stained skin tissue fixed using a 6 hour cold treatment in 30% NBF followed by a 1 hour hot treatment in 10% NBF. D. H&E stained skin tissue fixed using a standard 24 hour immersion in room temperature 10% NBF.

### DETAILED DESCRIPTION

### I. Abbreviations and Definitions

In order to facilitate review of the various examples of this disclosure, the following explanations of abbreviations and specific terms are provided:

H&E: Hematoxylin and eosin staining.

FFPE tissue: Formalin-fixed, paraffin-embedded tissue.

IHC: Immunohistochemistry.

ISH: In situ hybridization.

NBF: neutral buffered formalin solution.

Analyte: A molecule or group of molecules that are to be specifically detected in a sample.

Analyte-binding entity: Anything that is capable of specifically binding to an analyte. Examples of analyte-binding entities include: antibodies and antibody fragments (including single chain antibodies), which bind to target antigens; t-cell receptors (including single chain receptors), which bind to MHC:antigen complexes; MHC: peptide multimers (which bind to specific T-cell receptors); aptamers, which bind to specific nucleic acid or peptide targets; zinc fingers, which bind to specific nucleic acids, peptides, and other molecules; receptor complexes (including single chain receptors and chimeric receptors), which bind to receptor ligands; receptor ligands, which bind to receptor complexes; and nucleic acid probes, which hybridize to specific nucleic acids.

Antibody: The term “antibody” herein is used in the broadest sense and encompasses various antibody structures, including but not limited to monoclonal antibodies, polyclonal antibodies, multispecific antibodies (e.g., bispecific antibodies), and antibody fragments so long as they exhibit the desired antigen-binding activity.

Antibody fragment: A molecule other than an intact antibody that comprises a portion of an intact antibody that binds the antigen to which the intact antibody binds. Examples of antibody fragments include but are not limited to Fv, Fab, Fab′, Fab′-SH, F(ab′)2; diabodies; linear antibodies; single-chain antibody molecules (e.g. scFv); and multispecific antibodies formed from antibody fragments.

Anti-phospho-antibody: An antibody or antibody fragment that binds to a phosphorylated protein or amino acid residue, but not to a non-phosphorylated version of the same protein or amino acid residue. Examples of anti-phospho antibodies include:
antibodies specific for a specific phosphorylated amino acid residue, such as phosphorylated histidine (anti-phospho-His), phosphorylated serine (anti-phospho-Ser), phosphorylated threonine (anti-phospho-Thr), and phosphorylated tyrosine (anti-phospho-Tyr); and
antibodies specific for a particular antigen containing a phosphorylated amino acid, e.g. Akt phosphorylated at serine 473 (anti-phospho-Akt (Ser473))

Antigen: A compound, composition, or substance that may be specifically bound by the products of specific humoral or cellular immunity, such as an antibody molecule or T-cell receptor. Antigens can be any type of molecule including, for example, haptens, simple intermediary metabolites, sugars (e.g., oligosaccharides), lipids, and hormones as well as macromolecules such as complex carbohydrates (e.g., polysaccharides), phospholipids, nucleic acids and proteins. Common categories of antigens include, but are not limited to, viral antigens, bacterial antigens, fungal antigens, protozoa and other parasitic antigens, tumor antigens, antigens involved in autoimmune disease, allergy and graft rejection, toxins, and other miscellaneous antigens. In one example, an antigen is a Bacillus antigen, such as γPGA.

Formalin: A saturated aqueous solution of formaldehyde, which typically contains ˜40% formaldehyde by volume (˜37% by mass). Also referred to as “100% formalin.” In aqueous solution, formaldehyde forms a hydrate, methanediol (H₂C(OH)₂), which exists in equilibrium with various formaldehyde oligomers, depending on the concentration and temperature. Therefore, a small amount of stabilizer, such as methanol, is usually added to suppress oxidation and polymerization. A typical commercial grade formalin may contain 10-15% methanol in addition to various metallic impurities.

“X-% formalin”: A liquid composition containing an equivalent amount of formaldehyde as formalin (as defined above) diluted in a solvent to the specified percentage on a volume to volume basis. Thus, for example, a 30% formalin solution is a solution that contains an equivalent amount of formaldehyde as a solution containing 3 parts by volume formalin (as defined above) to 7 parts by volume solvent.

Phosphatase: Any polypeptide—or complex or fragment thereof—that catalyzes the cleavage of a phosphate bond.

Phosphatase inhibitor: Any molecule that specifically inhibits the ability of a phosphatase to cleave a phosphate bond.

Kinase: Any polypeptide—or complex or fragment thereof—that catalyzes the formation of a phosphate bond on a biomolecule.

Kinase inhibitor: Any molecule that specifically inhibits the ability of a kinase to catalyze the formation of a phosphate bond.

Protease: Any polypeptide—or complex or fragment thereof—that catalyzes the cleavage of a peptide bond.

Protease inhibitor: Any molecule that specifically inhibits the ability of a protease to catalyze the cleavage of a peptide bond.

Nuclease: Any polypeptide—or complex or fragment thereof—that catalyzes the cleavage of the phosphodiester bonds between the nucleotide subunits of nucleic acids.

Nuclease inhibitor: Any molecule that specifically inhibits the ability of a nuclease to catalyze the cleavage of the phosphodiester bonds between the nucleotide subunits of nucleic acids.

Peptide: The term “peptide” is intended to encompass any arrangement of two or more amino acids joined together by amide bonds, including oligopeptides and polypeptides. When the amino acids are alpha-amino acids, either the L-optical isomer or the D-optical isomer can be used.

Oligopeptide: A peptide from 2 to 20 amino acids in length.

Polypeptide: A peptide longer than 20 amino acids in length. The terms “polypeptide” or “protein” as used herein are intended to encompass any amino acid sequence and include modified sequences such as glycoproteins.

Post-translation modification: A chemical modification of a protein after its translation. It is one of the later steps in protein biosynthesis, and thus gene expression, for many proteins. The post-translational modification of amino acids extends the range of functions of the protein by attaching it to other biochemical functional groups (such as acetate, phosphate, various lipids and carbohydrates), changing the chemical nature of an amino acid (e.g. citrullination), or making structural changes (e.g. formation of disulfide bridges). Also, enzymes may remove amino acids from the amino end of the protein, or cut the peptide chain in the middle. For instance, the peptide hormone insulin is cut twice after disulfide bonds are formed, and a pro-peptide is removed from the middle of the chain; the resulting protein consists of two polypeptide chains connected by disulfide bonds. Also, most nascent polypeptides start with the amino acid methionine because the “start” codon on mRNA also codes for this amino acid. This amino acid is usually taken off during post-translational modification. Other modifications, like phosphorylation, are part of common mechanisms for controlling the behavior of a protein, for instance activating or inactivating an enzyme.

Sample: A biological specimen obtained from a subject containing genomic DNA, RNA (including mRNA), protein, or combinations thereof. Examples include, but are not limited to, peripheral blood, urine, saliva, tissue biopsy, surgical specimen, amniocentesis samples and autopsy material.

Specific binding: Specific binding occurs when an entity binds to a molecule in a sample to the substantial exclusion of binding to other molecules. For example, an entity may be considered to specifically bind to a given molecule when it has a binding constant that is at least 10³ M⁻¹ greater, 10⁴ M⁻¹ greater or 10⁵ M⁻¹ greater than a binding constant for other molecules in the sample.

Two-temperature fixation: As used herein, the term “two-temperature fixation” refers to a fixation protocol using an aldehyde-based fixative in which the tissue sample is first immersed in an aldehyde-based fixative at a cold temperature for a sufficient period of time to allow the fixative to diffuse throughout the tissue without substantially fixing the tissue sample, and then immersed in an aldehyde-based fixative at a high temperature for a sufficient period of time to allow the aldehyde to fix the tissue sample.

### II. Introduction

Fixation preserves a biological sample (tissue or cells) for subsequent examination. There are three main methods for fixing a tissue sample. Heat fixation involves exposing a sample to sufficient heat for sufficient time to abolish the activity of cellular proteins and thereby halt cellular metabolism. Heat fixation generally preserves cellular morphology but not protein structures.

Perfusion fixes a sample by blood flow. A fixative is injected into the heart and spreads through the entire body. This process preserves morphology, but the subject dies and the process is expensive because of the volume of fixative needed.

Chemical fixation involves immersing a tissue sample in a volume of chemical fixative, typically at least 20 times the volume of the tissue to be fixed. The fixative diffuses through the tissue sample and preserves structures (both chemically and structurally) as close to that of living tissue as possible. Cross-linking fixatives, typically aldehydes, create covalent chemical bonds between endogenous biological molecules, such as proteins and nucleic acids, present in the tissue sample. Formaldehyde is the most commonly used fixative in histology. Formaldehyde may be used in various concentrations for fixation, but it primarily is used as 10% neutral buffered formalin (NBF), which is about 3.7% formaldehyde in an aqueous phosphate buffered saline solution. Paraformaldehyde is a polymerized form of formaldehyde, which depolymerizes to provide formalin when heated. Glutaraldehyde operates in similar manner as formaldehyde, but is a larger molecule having a slower rate of diffusion across membranes. Glutaraldehyde fixation provides a more rigid or tightly linked fixed product, causes rapid and irreversible changes, fixes quickly and well at 4° C., provides good overall cytoplasmic and nuclear detail, but is not ideal for immunohistochemistry staining. Some fixation protocols use a combination of formaldehyde and glutaraldehyde.

Glyoxal and acrolein are less commonly used aldehydes.

### III. Development Background

It is well known that tissue fixation kinetics can be increased by raising the temperature of the fixative. However, placing a tissue sample directly into a heated fixative can cause the outside of the tissue to cross-link well before formalin penetrated to the center of the tissue, which in turn retards or even prevents further diffusion of the fixative into the tissue. As a result, biomolecules in the center of the tissue are heated without any significant cross-linking, rendering these molecules more susceptible to degradation and damage.

It was previously demonstrated that the degree of degradation and damage could be reduced by first “pre-soaking” the tissue samples in cold fixative to allow the fixative to diffuse throughout the tissue, followed by a higher temperature treatment to spur the cross-linking of proteins. See US 2012-0214195 A1. We have found that this method can be improved by increasing the aldehyde concentration during the cold temperature pre-soak. The increased aldehyde concentration appears to increase the rate of diffusion without significantly affecting tissue morphology. As a result, post-translational modifications are better preserved compared to using standard aldehyde concentrations in the cold soak step.

### IV. Samples

In principle, the present methods may be used with any sample type that can be fixed with aldehyde-based fixatives, including cell samples (such as circulating tumor cells or peripheral blood samples and fractions thereof) and tissue samples (such as tumor core biopsies and tumor resections).

In one embodiment, the sample is a tissue sample. Typically, tissue samples for immersion fixation are limited in size to ensure that fixative diffusion occurs quickly enough and adequately enough to preserve tissue morphology. Thus, certain tissue samples, such as tumor resections and whole organs, must be dissected before fixation to ensure adequate diffusion of the fixative. This is particularly true when the tissue contains analytes of interest that are subject to degradation by residual enzyme activity in the tissue. The present methods, however, increase diffusion speed and thus enable fixation of thicker-than-normal tissue samples. In an embodiment, the tissue may be as large as a tumor resection or a whole organ. In another embodiment, the tissue sample is a tissue biopsy, such as a core needle biopsy.

The present uses, methods, and compositions are especially useful in preserving post-translational modifications.

### V. Fixative Compositions

### A. Aldehyde Concentration

The present uses, compositions, methods, and systems rely on aldehyde-based fixative solutions having higher-than-normal concentrations of aldehyde (“high-concentration aldehyde-based fixative solution”), which is shown below to increase the rate of diffusion into the tissue and to improve the detection of post-translationally modified proteins.

Standard aldehyde concentrations used for fixation include:
formaldehyde (standard working concentration of 5-10% formalin for most tissues, although concentrations as high as 20% formalin have been used for certain tissues);
glyoxal (standard working concentration 17 to 86 mM);
glutaraldehyde (standard working concentration of 200 mM).

Aldehydes are often used in combination with one another. Standard aldehyde combinations include 10% formalin+1% (w/v) Glutaraldehyde.

Atypical aldehydes that have been used in certain specialized fixation applications include: fumaraldehyde, 12.5% hydroxyadipaldehyde (pH 7.5), 10% crotonaldehyde (pH 7.4), 5% pyruvic aldehyde (pH 5.5), 10% acetaldehyde (pH 7.5), 10% acrolein (pH 7.6), and 5% methacrolein (pH 7.6).

The aldehyde concentration used in the present uses, methods, compositions, and systems is higher than these standard concentrations.

In an embodiment, the high-concentration aldehyde-based fixative solution has an aldehyde concentration that is at least 1.25-times higher than the standard concentration used to fix a selected tissue for immunohistochemistry with a substantially similar composition. For example, if a 10% phosphate buffered formalin is typically used to fix a particular tissue, then in this embodiment, at least 12.5% phosphate buffered formalin may be used.

In another embodiment, the high-concentration aldehyde-based fixative solution has a concentration of aldehyde that results in a statistically significant improvement in the rate of diffusion through a selected tissue relative to the same composition containing the highest standard aldehyde concentration used for the selected tissue. In an embodiment, the high-concentration aldehyde-based fixative solution has an aldehyde concentration and pH sufficient to obtain a reduced time of diffusion to reach decay constant as determined according to Bauer et al. of at least 22% and up to 275% at a temperature of 2° C. to 8° C. relative to a standard concentration of aldehyde used for fixing the tissue sample.

In an exemplary embodiment, the high-concentration aldehyde-based fixative solution is selected from: greater than 20% formalin, about 25% formalin or greater, about 27.5% formalin or greater, about 30% formalin or greater, from about 25% to about 50% formalin, from about 27.5% to about 50% formalin, from about 30% to about 50% formalin, from about 25% to about 40% formalin, from about 27.5% to about 40% formalin, and from about 30% to about 40% formalin. As used in this context, the term “about” shall encompass concentrations that do not result in a statistically significant difference in diffusion at 4° C. as measured by Bauer et al.

### B. Buffers and pH

The high-concentration aldehyde-based fixative solutions used in the present uses, compositions, methods and systems may optionally contain at least one buffer. Exemplary buffers are listed at Table 1:

TABLE 1

| | Useful | pKa | pKa | pKa | |
|---|---|---|---|---|---|
| Common | pH | (20° | (25° | (37° | |
| Name | Range | C.) | C.) | C.) | Full Name |
| Bis-Tris | 5.8-7.2 | n/a | 6.5 | 6.36 | 2,2-Bis(hydroxymethyl)- |
| | | | | | 2,2′,2″-nitrilotriethanol |
| PIPES | 6.1-7.5 | 6.8 | 6.76 | 6.66 | 1,4- |
| | | | | | Piperazinediethanesulfonic |
| | | | | | acid |
| MOPSO | 6.2-7.6 | n/a | 6.9 | 6.75 | β-Hydroxy-4- |
| | | | | | morpholinepropanesulfonic |
| | | | | | acid |
| BES | 6.4-7.8 | 7.17 | 7.09 | 6.9 | N,N-Bis(2-hydroxyethyl)- |
| | | | | | 2-aminoethanesulfonic |
| | | | | | acid |
| MOPS | 6.5-7.9 | 7.28 | 7.2 | 7.02 | 3-(N-Morpholino) |
| | | | | | propanesulfonic |
| | | | | | acid |
| HEPES | 6.8-8.2 | 7.55 | 7.48 | 7.31 | 4-(2-Hydroxyethyl) |
| | | | | | piperazine- |
| | | | | | 1-ethanesulfonic acid |
| DIPSO | 7.0-8.2 | n/a | 7.6 | 7.35 | 3-(N,N-Bis[2- |
| | | | | | hydroxyethyl]amino)-2- |
| | | | | | hydroxypropanesulfonic |
| | | | | | acid |
| MOBS | 6.9-8.3 | n/a | 7.6 | n/a | 4-(N- |
| | | | | | Morpholino) |
| | | | | | butanesulfonic acid |
| HEPPSO | 7.1-8.5 | n/a | 7.8 | 6.66 | 4-(2-Hydroxyethyl) |
| | | | | | piperazine-1-(2- |
| | | | | | hydroxypropanesulfonic |
| | | | | | acid) |
| POPSO | 7.2-8.5 | n/a | 7.8 | 7.63 | Piperazine-1,4-bis(2- |
| | | | | | hydroxypropanesulfonic |
| | | | | | acid) dihydrate |
| EPPS | 7.3-8.7 | n/a | 8 | n/a | 4-(2-Hydroxyethyl)-1- |
| | | | | | piperazinepropanesulfonic |
| | | | | | acid |
| Imidazole | 6.2-7.8 | 6.9 | | | n/a |
| Maleate | 5.6-7.0 | 6.3 | | | n/a |
| Phos- | 5.8-8.0 | 7.2 | | | n/a |
| phate | | (pKa2) | | | |

In an embodiment, the high concentration aldehyde-based fixative solution is buffered at a pH from about 6 to 8 at 25° C. In another embodiment, the high concentration aldehyde-based fixative solution comprises at least one buffer selected from Table 1.

In another exemplary embodiment, a formaldehyde-based composition is neutral buffered formalin. Exemplary neutral buffered formalin compositions are disclosed at Table 2:

TABLE 2

| | | 25% | 30% | 35% | 40% |
|---|---|---|---|---|---|
| | | NBF | NBF | NBF | NBF |
| Solution | pH | 6.81 | 6.80 | 6.80 | 6.79 |
| Formulation | Concentrated Formalin | 250 | 300 | 350 | 400 |
| | Solution (mL) | | | | |
| | 1M Phosphate Buffer pH 6.85 | 75 | 75 | 75 | 75 |
| | (mL) | | | | |
| | H₂O (mL) | 675 | 625 | 575 | 525 |
| | Solution Volume (mL) | 1000 | 1000 | 1000 | 1000 |
| Composition | Formaldehyde (% w/v) | 9.1 | 11.0 | 12.8 | 14.6 |
| | Formaldehyde Solution (% v/v) | 25 | 30 | 35 | 40 |
| | Methanol (%) | 3.8 | 4.5 | 5.3 | 6.0 |
| | Monobasic Phosphate (mM) | 28.8 | 28.8 | 28.8 | 28.8 |
| | Dibasic Phosphate (mM) | 46.1 | 46.1 | 46.1 | 46.1 |
| | Total Phosphate (mM) | 75.0 | 75.0 | 75.0 | 75.0 |
| | H₂O (%) | 67.5 | 62.5 | 57.5 | 52.5 |

### C. Stabilizers

The aldehyde-based fixative solutions used in the present uses, compositions, methods and systems may also optionally contain a stabilizer. Stabilizers are used to prevent formaldehyde polymerization and/or oxidation. Exemplary stabilizers include alkanols, such as methanol, ethanol, glycerol, and sugars (such as sucrose).

### D. Osmolarity and Inorganic Salts

The high-concentration aldehyde-based fixative solutions used in the present uses, compositions, methods and systems may also optionally contain one or more inorganic salt. Typically, salts are added to adjust the osmolarity of the solution to prevent swelling or shrinking of the cells, although some salts may also assist with fixation of the tissue. In an embodiment, the high-concentration aldehyde-based fixative solution contains sufficient salt concentration to substantially prevent shrinking or swelling of cells in the tissue sample. Different cells and structures could need anything from isotonic to hypertonic solutions to retain morphology. Thus, in an embodiment, the high-concentration aldehyde-based fixative solution has an osmolarity in the range of 300 to 1200 mOsm/L at 25° C.

Common inorganic salts used in aldehyde-based fixatives include sodium salts, such as sodium chloride, sodium acetate, and sodium sulphate; calcium salts, such as calcium chloride; potassium salts, such as potassium dichromate; zinc salts, such as zinc chloride and zinc sulphate; mercuric salts, such as mercuric chloride; and copper salts, such as copper acetate. For example, some specialized inorganic salt-containing formalin solutions used for immunohistochemistry are set forth in Table 3:

TABLE 3

| Solution | Standard Composition |
|---|---|
| Formal Calcium | 10% formalin + 10 g/L calcium chloride |
| Formal Saline | 10% formalin + 9 g/L sodium chloride |
| Zinc Formalin | 10% formalin + 1 g/L zinc sulphate |
| Helly's Fixative | 50 mL 100% formalin + 1 L aqueous solution |
| | containing 25 g/L potassium dichromate + 10 |
| | g/L sodium sulfate + 50 g/L mercuric chloride |
| B-5 Fixative | 2 mL 100% formalin + 20 mL aqueous solution |
| | containing 6 g/L mercuric chloride + 12.5 g/L |
| | sodium acetate (anhydrous) |
| Hollande's | 100 mL 100% formalin + 15 mL Acetic acid + |
| Solution | 1 L aqueous solution comprising 25 g copper |
| | acetate and 40 g picric acid |
| Bouin's Solution | 250 mL 100% formalin + 750 mL saturated |
| | aqueous picric acid + 50 mL glacial acetic acid |

In an embodiment, the high-concentration aldehyde-based fixative solution is a modified form of one of the solutions of Table 3, in which a higher-than-standard formalin concentration is used. In an embodiment, the modified form of the solution of Table 3 has an aldehyde concentration that is at least 1.25-times higher than the standard concentration listed in Table 3. In another embodiment, the modified form of the solution of Table 3 has a concentration of aldehyde that results in a statistically significant improvement in the rate of diffusion through a selected tissue relative to the composition of Table 3. In another embodiment, the high-concentration aldehyde-based fixative solution has an aldehyde concentration and pH sufficient to obtain a reduced time of diffusion to reach decay constant as determined according to Bauer et al. of at least 22% and up to 275% at a temperature of 2° C. to 8° C. relative to a standard concentration of aldehyde used for fixing the tissue sample.

### E. Degradation Inhibitors

Another feature of the present uses, compositions, methods, and systems is that they do not need exogenous degradation inhibitors (such as phosphatase inhibitors, kinase inhibitors, protease inhibitors, or nuclease inhibitors) to substantially preserve post-translationally modified proteins in a state that they can be detected by immunohistochemistry. Therefore, although such degradation inhibitors may be included in the fixative solutions, they are not required. In an embodiment, the aldehyde-based fixative solutions do not contain an effective amount of exogenously added phosphatase inhibitor or kinase inhibitor. In other embodiments, the aldehyde-based fixative solutions do not contain an effective amount of phosphatase inhibitor, kinase inhibitor, protease inhibitor, or nuclease inhibitor.

### F. Additional Exemplary Embodiments

In an exemplary embodiment, the aldehyde-based fixative solutions used in the present uses, compositions, methods and systems may comprise, consist essentially of, or consist of:
an aldehyde at a higher-than-standard concentration for the tissue being fixed, preferably in aqueous solution;
optionally, one or more buffers and sufficient acid or base to adjust solution pH to a desired value;
optionally, one or more inorganic salt; and
optionally, one or more stabilizers.

In another exemplary embodiment, the aldehyde-based fixative solutions used in the present uses, compositions, methods and systems may comprise, consists essentially of, or consist of:
an aldehyde at a higher-than-standard concentration for the tissue being fixed;
optionally, one or more buffers and sufficient acid or base to adjust solution pH to a desired value;
optionally, one or more inorganic salt; and
optionally, one or more stabilizers;
   wherein an aldehyde concentration is used that is at least 1.25-times higher than the standard concentration used to fix a selected tissue for immunohistochemistry with a substantially similar composition.

In another exemplary embodiment, the aldehyde-based fixative solutions used in the present uses, compositions, methods and systems may comprise, consist essentially of, or consist of:
an aldehyde at a higher-than-standard concentration for the tissue being fixed;
optionally, one or more buffers and sufficient acid or base to adjust solution pH to a desired value;
optionally, one or more inorganic salt; and
optionally, one or more stabilizers;
   wherein an aldehyde concentration is used that results in a statistically significant improvement in the rate of diffusion through a selected tissue relative to the same composition containing the highest standard aldehyde concentration used for the selected tissue.

In another exemplary embodiment, the aldehyde-based fixative solutions used in the present uses, compositions, methods and systems may comprise, consist essentially of, or consist of:
greater than 20% formalin, for example, 25% or greater formalin, 27.5% or greater formalin, 30% or greater formalin, from 25% to 50% formalin, from 27.5% to 50% formalin, from 30% to 50% formalin, from 25% to 40% formalin, from 27.5% to 40% formalin, or from 30% to 40% formalin;
optionally, one or more buffers and sufficient acid or base to adjust solution pH to a desired value;
optionally, one or more inorganic salt; and
optionally, one or more stabilizers.

In another exemplary embodiment, the aldehyde-based fixative solutions used in the present uses, compositions, methods and systems may comprise, consist essentially of, or consist of a greater than 20% neutral buffered formalin, for example, 25% or greater formalin, 27.5% or greater formalin, 30% or greater formalin, from 25% to 50% formalin, from 27.5% to 50% formalin, from 30% to 50% formalin, from 25% to 40% formalin, from 27.5% to 40% formalin, or from 30% to 40% formalin.

In another exemplary embodiment, the aldehyde-based fixative solutions used in the present uses, compositions, methods and systems may comprise, consist essentially of, or consist of a formalin solution selected from the group consisting of formal calcium, formal saline, zinc formalin, Helly's fixative, B-5 fixative, Hollande's Solution, or Bouin's Solution, with the proviso that the composition is modified to contain at least 1.25-fold greater concentration formaldehyde than the standard composition.

In another exemplary embodiment, the aldehyde-based fixative solutions used in the present uses, compositions, methods and systems may comprise, consist essentially of, or consist of a formalin solution selected from the group consisting of formal calcium, formal saline, zinc formalin, Helly's fixative, B-5 fixative, Hollande's Solution, or Bouin's Solution, with the proviso that the composition is modified to contain a sufficiently increased formalin concentration to effect a statistically significant improvement in the rate of diffusion through a selected tissue relative to the standard composition.

In the context of these exemplary embodiments, the term “consists essentially of” shall mean that the composition does not contain any additional additives at a concentration sufficient either to substantially alter the rate of diffusion into the tissue at 4° C. relative to the same composition without the additional additives or to substantially alter the degree to which post-translational modifications are preserved in the sample relative to the composition without the additional additives.

### VI. Fixation Process

Certain disclosed embodiments concern a multi-step, typically a two-step, tissue fixation process for infusing/diffusing a tissue sample using the high-concentration aldehyde-based fixative solutions described above. During a first step, a tissue sample is treated with the high concentration aldehyde-based fixative solution as described above under conditions that allow the fixative to diffuse throughout substantially the entire cross section of the sample. This first step is conducted using a fixative composition for a first period of time, and at a first temperature, that effects substantially complete tissue infusion/diffusion. The second step is to subject the tissue sample to a fixative composition at a second, higher temperature to allow cross-linking to occur at as fast a rate as possible without compromising the tissue characteristics, such as antigenicity and morphology.

For the following discussion of processing steps, a person of ordinary skill in the art will appreciate that various factors may be considered to deduce optimal processing conditions for a particular tissue sample. These factors include: sample thickness; volume of fixative solution to tissue sample mass, which typically is from about 10:1 to about 50:1 volume to mass; fixative composition; temperature; pH; and sample immersion time in the fixative composition. One advantage of the present compositions, methods, and systems is that the higher concentration of aldehyde permits

The preferred description of the first and second times of soaking in cross-linking fixative is based on the ASCO CAP guidelines where the preferred tissue thickness is up to approximately 4 mm. The tissue thickness can be less or more than 4 mm, even up to whole organs. Since the invention relies on a first diffusion step, thicker tissue sections would require a first time in cold fixative greater than the preferred 1-5 hours and up to 12 hours or more. In addition, anyone skilled in the art could understand that the second time in fixative solution might be greater than the preferred method of 1-5 hours and up to 8 hours or more. For example, a tissue sample of 6 mm thick might have a preferred first time in fixative solution of 4 hours and a second time in fixative solution of 4 hours or more. It is also understood in the art that some tissue types and some tissue organs may have slightly different times.

The first step of the process is to subject a tissue sample to high-concentration aldehyde-based under conditions effective to allow substantially complete diffusion of the composition throughout substantially the entire cross section of the sample. An effective temperature range for the first step is from greater than −20° C. to at least 15° C., preferably greater than 0° C. to an upper temperature more typically about 10° C., and even more typically from about 1° C. to about 7° C. For working embodiments, the temperature typically was about 4° C.

As the temperature increases, the rate of cross-linking increases. And this first processing step attempts to balance the beneficial properties associated with substantially complete diffusion of fixative composition throughout the entire cross section of the tissue sample while minimizing the effects associated with initializing cross-linking. However, diffusion also increases with increasing temperature, and so for a given sample, it has been found that maximizing the rate of diffusion while minimizing any deleterious effects associated with increased cross-linking rate appears to increase benefits.

Diffusion of the fixative composition into the tissue sample is continued for a time period effective for diffusion of the composition throughout substantially the entire cross section of the sample. The time period for the first processing step ranges from about 15 minutes up to about 4 hours, most typically from greater than 15 minutes to about 3 hours, with good results typically being obtained by conducting the fixative composition diffusion step for about 1.5 hours to about 2 hours. Although increasing the diffusion time to 4 hours or greater generally had little beneficial effect, leaving tissues in the cold formalin for an extended period of time (for example, up to 14 days) generally does not have a deleterious effect on processing.

The temperature associated with the second processing step typically is higher than ambient, such as higher than about 22° C. For working embodiments, the temperature typically was greater than ambient up to at least 55° C., more typically from about 35° C. to about 45° C., as this temperature range increases the cross-linking kinetics sufficiently to allow relatively quick tissue cross-linking. However, if the temperature is increased above about 50° C., the sample generally begins to degrade, which may have a deleterious effect on certain subsequent histological reactions. Thus, the upper temperature and time period are selected to allow subsequent imaging process steps, such as in situ hybridization, IHC and/or H & E, to proceed effectively. The time period for the second processing step ranges from greater than 15 minutes up to at least about 5 hours, more typically is at least about 1 hour to about 4 hours, and more typically is from about 2 hours to about 3 hours. In certain embodiments, the second processing step is conducted for 1.5 hours at 45° C.

### VII. Further Tissue Processing

After fixation, the tissue may be further processed to prepare it for storage and/or analysis. Many post-fixation processes are well-known and would be well understood by a person of ordinary skill in the art. For example, protocols for using zinc formalin, Helly's fixative and Hollande's require a water wash after fixation to remove various contaminates. Some protocols for Bouin's and B-5 suggest storing the fixed samples in 70% ethanol before processing. Additionally, some specimens may be difficult to cut on a microtome because of calcium carbonate or phosphate deposits, and thus may require decalcification. Other post-fixation tissue processing would be well-known to a person having ordinary skill in the art.

In one embodiment, the fixed and processed tissue may be paraffin embedded. In the typical example, the fixed tissue sample is subjected to a series of alcohol immersions to dehydrate the sample, typically using increasing alcohol concentrations ranging from about 70% to about 100%. The alcohol generally is an alkanol, particularly methanol and/or ethanol. After the last alcohol treatment step the sample is then immersed into another organic solvent, commonly referred to as a clearing solution. The clearing solution (1) removes residual alcohol, and (2) renders the sample more hydrophobic for a subsequent waxing step. The clearing solvent typically is an aromatic organic solvent, such as xylene. Wax blocks are formed by applying a wax, typically a paraffin wax, to the sample. Slides are then cut from the wax block.

After processing, the samples can be stored as frozen or paraffin-embedded blocks. Typically, before tissue analysis, the blocks are sliced into thin sections using a microtome.

### VIII. Post-Processing Analysis

Fixed tissue samples obtained by the processes and compositions disclosed herein can be used together with any staining systems and protocol known in the art of histochemistry, as well as immunohistochemistry and in situ hybridization. The present invention can also be used together with various automated staining systems, such as those marketed by Ventana Medical Systems, Inc., Tucson, Ariz., including the Benchmark XT, Benchmark Ultra, and Discovery automated platforms. Exemplary systems are disclosed in U.S. Pat. No. 6,352,861, U.S. Pat. No. 5,654,200, U.S. Pat. No. 6,582,962, U.S. Pat. No. 6,296,809, and U.S. Pat. No. 5,595,707, all of which are incorporated herein by reference.

Additional information concerning automated systems and methods also can be found in WO2010/080287, which is incorporated herein by reference. Chromogenic detection facilitates visual unaided deciphering of patterns on the device.

In an embodiment, specific analytes are detected using immunohistochemistry (IHC). In the typical IHC protocol, a tissue sample is contacted first with an analyte-specific antibody under conditions sufficient to permit specific binding of the analyte-specific antibody to the analyte.

In exemplary embodiments, detection of specific analytes is realized through antibodies capable of specific binding to the analyte (or antibody fragments thereof) conjugated with multiple enzymes (e.g. horse radish peroxidase (HRP), alkaline phosphatase (AP). This enzyme-antibody conjugate is referred to as an HRP or AP multimer in light of the multiplicity of enzymes conjugated to each antibody. Multimer technologies are described in U.S. Pat. No. 8,686,122 which is hereby incorporated by reference in its entirety for disclosure related to antibody conjugates. This type of detection chemistry technology is currently marketed by Ventana Medical Systems Inc., as ultraView Universal DAB detection kit (P/N 760-500), ultraView Universal AP Red detection kit (P/N 760-501), ultraView Red ISH DIG detection kit (P/N 760-505), and ultraView SISH DNP detection kit (P/N 760-098).

In illustrative embodiments, the approach uses non-endogenous haptens (e.g. not biotin, see U.S. Pat. No. 8,846,320 which is hereby incorporated by reference in its entirety for disclosure related to detection chemistries). In illustrative embodiments, a tyramide signal amplification may be used with this approach to further increase the sensitivity and dynamic range of the detection (See WO2012003476, which is hereby incorporated by reference in its entirety for disclosure related to detection chemistries).

Any suitable enzyme/enzyme substrate system can be used for the disclosed analysis/detection method. Working embodiments typically used alkaline phosphatase and horseradish peroxidase. If the enzyme is alkaline phosphatase, one suitable substrate is nitro blue tetrazolium chloride/(5-bromo-4-chloro-1H-indol-3-yl)dihydrogen phosphate (NBT/BCIP). If the enzyme is horseradish peroxidase, then one suitable substrate is diaminobenzidine (DAB). Numerous other enzyme-substrate combinations are known to those skilled in the art. For a general review of these, see U.S. Pat. Nos. 4,275,149, and 4,318,980. In some embodiments, the enzyme is a peroxidase, such as horseradish peroxidase or glutathione peroxidase or an oxidoreductase.

U.S. Patent Publication 2008/0102006, the entire disclosure of which is incorporated herein by reference, describes robotic fluid dispensers that are operated and controlled by microprocessors. U.S. Patent Publication 2011/0311123, the entire disclosure of which is incorporated herein by reference, describes methods and systems for automated detection of immunohistochemical (IHC) patterns. The automated detection systems disclosed in these patent applications can be used to detect analytes in the fixed tissue samples of the present invention.

In especially preferred embodiments, the fixed tissue samples are analyzed by immunohistochemistry for the presence of post-translationally modified proteins. In the typical process, the fixed tissue sample is contacted with an analyte-binding entity capable of specifically binding to the post-translationally modified protein under conditions sufficient to effect binding of the analyte-binding entity to the post-translationally modified protein; and binding of the analyte-binding entity to the post-translationally modified protein is detected. The precise conditions for effective IHC generally need to be worked on an individual basis, depending upon, for example, the precise antibody used, the type of sample used, sample size, further processing steps, et cetera.

In an embodiment, the post-translational modification is one that is susceptible to loss during a standard aldehyde fixation process due to residual enzyme activity within the tissue sample. One could determine whether a given post-translational modification is susceptible to residual enzyme activity by treating a sample with an entity that leads to increased presence of the post-translational modification. The sample could then be fixed using a standard technique (such as 24 hour fixation in room temperature NBF) and a fixation process as disclosed herein and the amount of signal detectable in each of the samples can be compared. If signal is absent or significantly lower in the sample fixed according to standard techniques, then one can assume that the post-translational modification is susceptible to degradation by residual enzyme activity. Thus, in an embodiment, the post-translational modification is a post-translational modification that is substantially undetectable in a tissue fixed for 24 hours in room temperature NBF without a cold temperature pre-treatment, but is detectable in a substantially identical tissue sample that has been fixed using a two-temperature fixation using a high-concentration aldehyde-based fixative solution as described above in the cold temperature step.

In an embodiment, the post-translational modification is a diagnostic or prognostic marker for a disease state of the tissue sample. In an embodiment, the post-translational modification is a predictive marker for an effect of a therapy on a disease state of the tissue. In an embodiment, the post-translational modification is a phosphorylation.

### IX. Examples

### Example 1

H-scores for pAKT staining level in colorectal cancer tissues are summarized for a set of 10 specimen collected with controlled cold ischemia condition (5-15 minutes). Each sample was cut into two groups of specimen sizes: 3 biopsies, “Biop” (typically with 2 mm diameter), and 3 resections, “Spec” (typically 10×10×5 mm). All specimen were then immersed into either 4° C. cold formalin with 10% or 30% concentrations, or RT 10% formalin. Samples were then stained for phospho-Akt using an anti-phospho-Akt (Ser473) monoclonal antibody (Cell Signaling Technologies). The following formula was used to calculate individual Hscores per sample:

Hscore=(low %)*1+(medium %)*2+(high %)*3

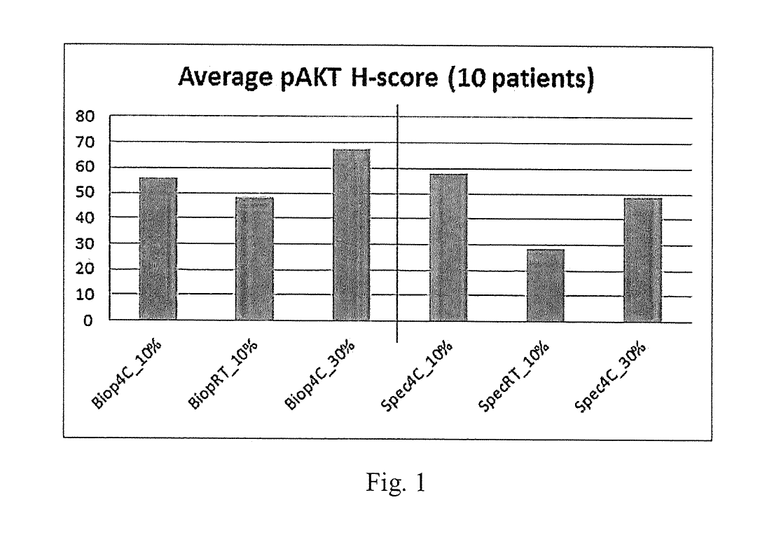

Results are shown at FIG. 1. Graph represents average pAKT Hscore for all 10 patient samples. For both sample sizes, the cold fixation method shows superior staining levels, with 30% showing the strongest Hscores.

### Example 2

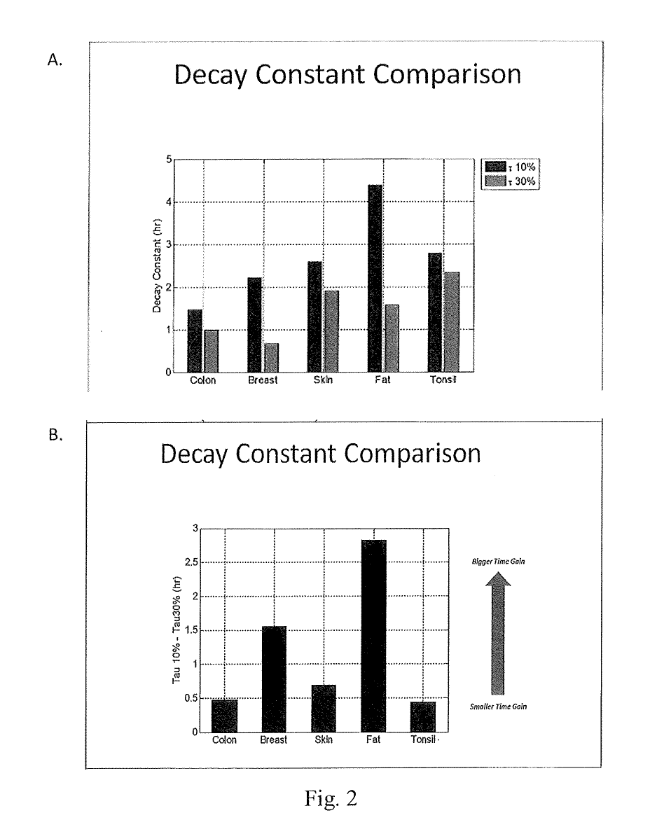

6 mm thick samples of colon, breast, skin, fat, and tonsil tissue were immersed in either 10% NBF or 30% NBF at 4° C. and the rate of fixative penetration was measured by the method of Bauer et al. (incorporated herein by reference in its entirety). Results are shown at FIGS. 2A and 2B. In FIG. 2A, the diffusion trend over time was fit to a single exponential curve. The reported decay constant, measured in hours, of that exponential curve mathematically represents the time it takes the signal to decrease by 63% of its entire amplitude and was thus used as a quantitative metric of how long diffusion takes. In FIG. 2B, diffusion speed gain comparing rate of diffusion with 30% vs 10% NBF was calculated as the differential of the decay constant's from each respective reagent. All types of tissue display noticeably faster diffusion in 30% NBF. The rate of diffusion increase was calculated as 100*(10% decay constant)/(30% decay constant), e.g. for fat 100*4.4 hr/1.6 hr=275% faster.

### Example 3

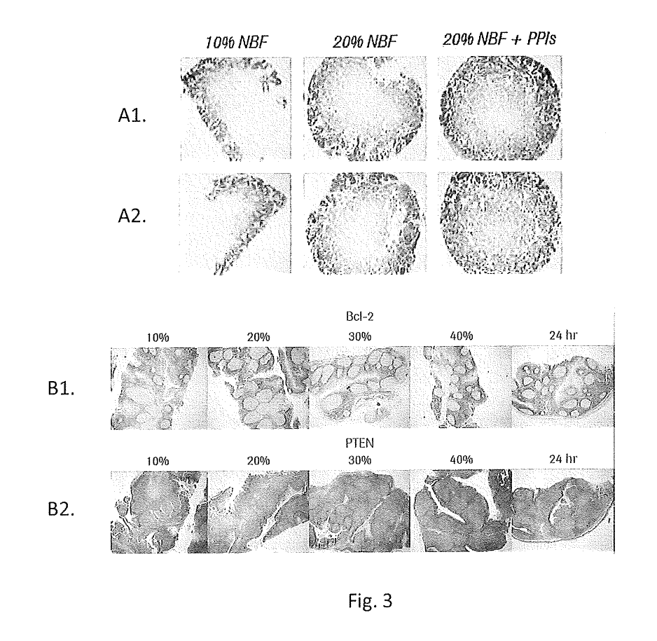

FIG. 3, Row A1 and A2 Calu3 Xenograft tumors were harvested and placed into fixative within 5 minutes. A biopsy coring device was used to remove 6 mm diameter samples from xenografts tumors to ensure the samples were of uniform size. Cores were placed into 4° C. formalin at 10%, 20% or 20%+a phosphatase inhibitor cocktail for 2 hours. Cores were then placed into 45° C. 10% NBF for 2 hours to initiate crosslinking. Samples were processed, embedded in wax and stained with an anti-pAKT antibody. FIG. 3, Row B1 and B2 Human tonsil samples cut to 4 mm thickness were placed into 4° C. formalin at 10%, 20%, 30%, or 40% NBF for 2 hours. Samples were then placed into 45° C. 10% NBF for 2 hours to initiate crosslinking. An additional sample was placed into room temperature (RT) 10% NBF for 24 hours as a control. All samples were processed, embedded and stained with either bcl-2 (B1) or PTEN (B2). Results are shown at FIG. 3.

### Example 4

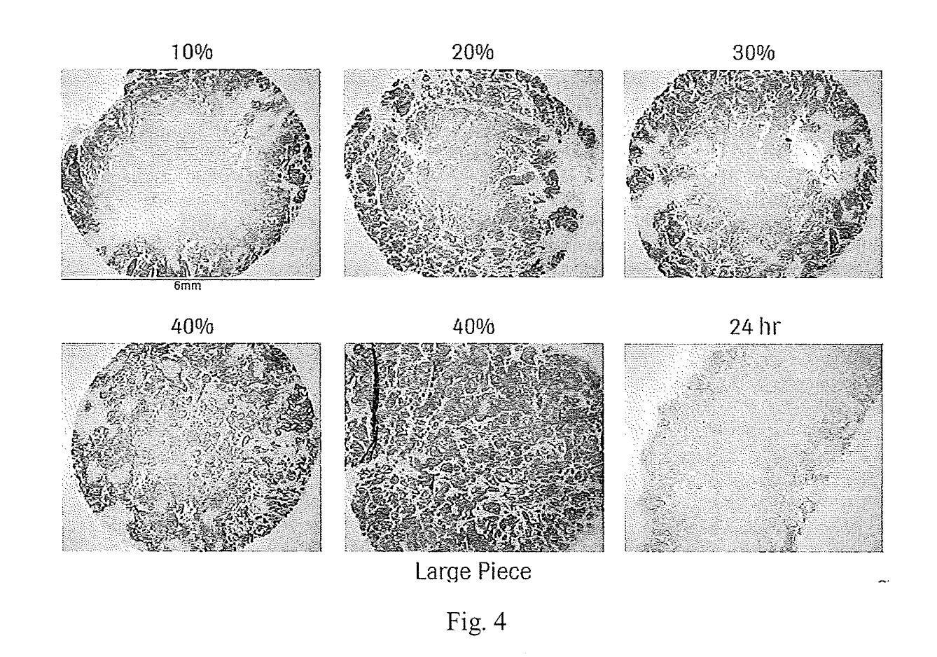

Calu3 Xenograft tumors were harvested and placed into fixative within 5 minutes. A biopsy coring device was used to remove 6 mm diameter samples from xenografts tumors to ensure the samples were of uniform size. Cores were placed into 4° C. formalin at 10%, 20%, 30%, or 40% NBF for 2 hours. Samples were then placed into 45° C. 10% NBF for 2 hours to initiate crosslinking. An additional larger sample (piece) was placed into 4° C. 40% formalin. An additional sample was placed into room temperature (RT) 10% NBF for 24 hours as a control. All samples were processed, embedded and stained with an anti-pAKT antibody. Results are shown at FIG. 4.

### Example 5

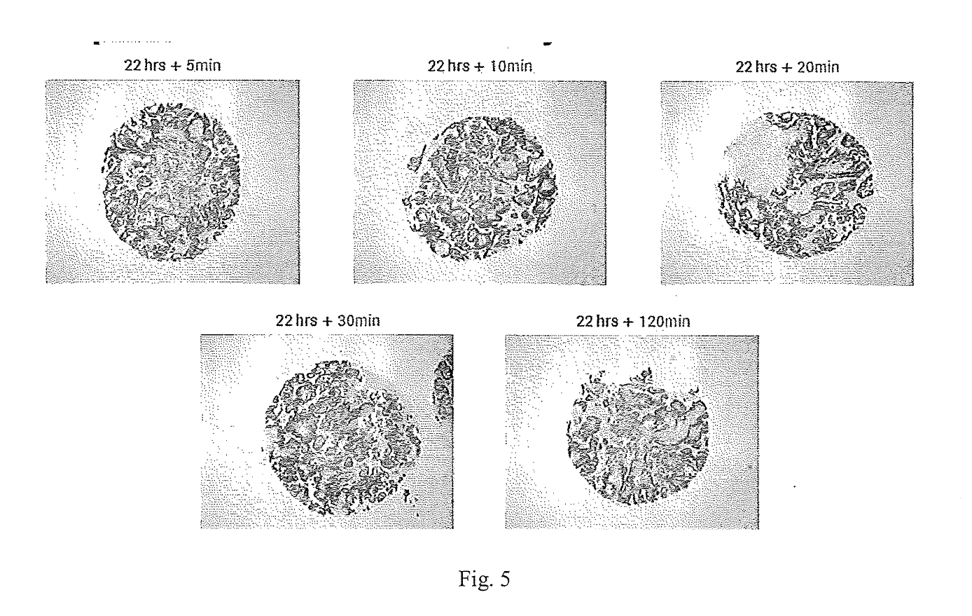

Calu3 Xenograft tumors were harvested and placed into fixative within 5 minutes. A biopsy coring device was used to remove 6 mm diameter samples from xenograft tumors to ensure the samples were of uniform size. Cores were placed into 30% NBF at 4° C. for 22 hours to ensure maximum diffusion of fixative. Samples were then placed into 45° C. 10% NBF for indicated times (5-120 minutes). All samples were processed, embedded and stained with an anti-pAKT antibody. Results are shown at FIG. 5.

### Example 6

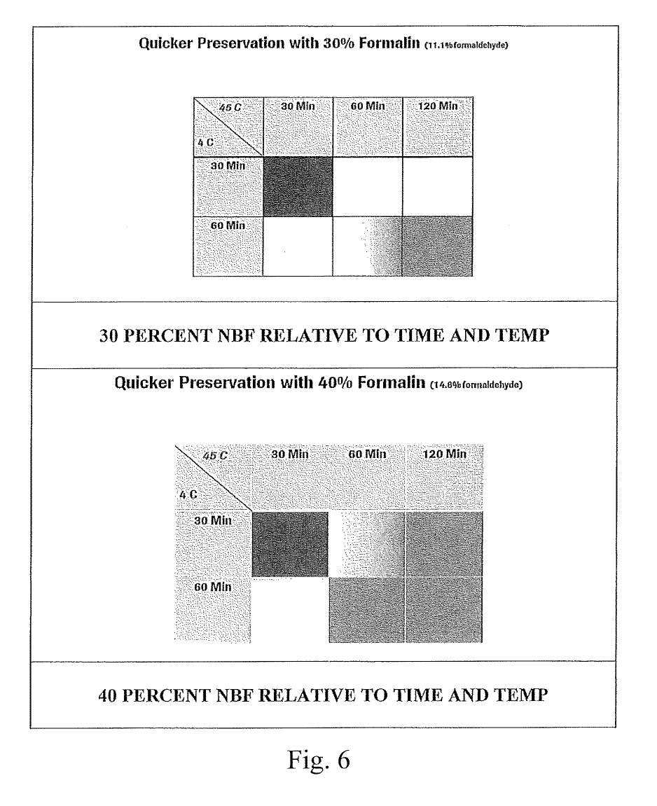

Human tonsil samples were cut to 4 mm thickness and placed into 30% NBF at 4° C. for indicated times (along y axis, 30 or 60 minutes). Samples were then placed into 45° C. 10% NBF for 0.5, 1 or 2 hours to initiate crosslinking (along X axis, 30-120 minutes). All samples were processed, embedded and stained with hematoxylin and eosin and evaluated for quality of tissue morphology. Results are shown at FIG. 6.

### Example 7

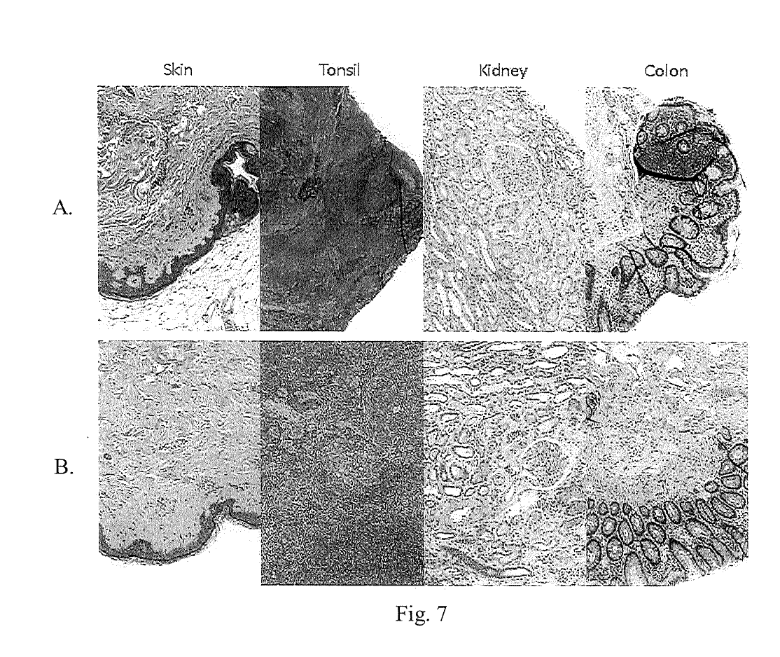

Human tissue samples (colon, kidney, tonsil and skin) were collected, sliced to 4 mm thickness. Pieces of the samples were placed into room temperature (RT) 10% NBF for 24 hours as controls. Identical samples were also placed into 30% NBF at 4° C. for 2 hours. Samples were then placed into 45° C. 10% NBF for 2 hours to initiate crosslinking. All samples were processed, embedded and stained with hematoxylin and eosin and evaluated for quality of tissue morphology. Results are shown at FIG. 7.

### Example 8

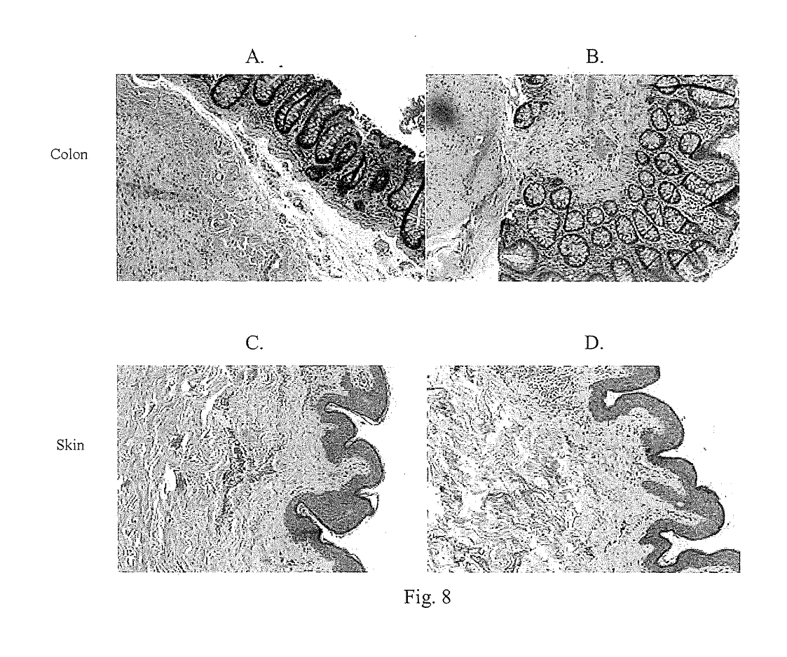

Human colon tissue and skin tissue was fixed using either: (a) a 6 hour cold (4° C.) pretreatment treatment in 30% NBF followed by a 1 hour hot treatment (45° C.) in 10% NBF; or (b) a standard 24 hour immersion in room temperature 10% NBF. The fixed tissue was subsequently stained with H&E and slides examined by a trained pathologist. The pathologist concluded that all of the slides exhibited “adequate, i.e. essentially perfect, H&E histology.” Exemplary images are shown in FIG. 8.

### REFERENCES

Bauer et al., Dynamic Subnanosecond Time-of-Flight Detection for Ultra-precise Diffusion Monitoring and Optimization of Biomarker Preservation, Proceedings of SPIE, Vol. 9040, 90400B-1 (2014 Mar. 20).
Krueger and Srivastava, Posttranslational Protein Modifications: Current Implications for Cancer Detection, Prevention, and Therapeutics, Molecular & Cellular Proteomics, Vol. 5, Issue 10, p. 1799-810 (2006 Jul. 14).
Lawson et al. Cytotoxicity effects of cryoprotectants as single-component and cocktail vitrification solutions, Cryobiology, vol. 62, issue 2, p. 115-122 (2011 Jan. 22).

1. A composition comprising a tissue sample immersed in a high-concentration aldehyde-based fixative solution, wherein the high-concentration aldehyde-based fixative solution has an aldehyde concentration at least 1.25-times higher than the highest concentration of the aldehyde used in standard immunohistochemical fixation of the tissue.

2. A composition comprising a tissue sample immersed in a high-concentration aldehyde-based fixative solution, wherein the high-concentration aldehyde-based fixative solution has an aldehyde concentration and pH sufficient to obtain a reduced time of diffusion to reach decay constant of at least 22% and up to 275% at a temperature of 2° C. to 8° C.

3. The composition of claim 2, wherein the high-concentration aldehyde-based fixative solution has an aldehyde concentration at least 1.25-times higher than the highest concentration of the aldehyde used in standard fixatives for immunohistochemistry on the tissue.

4. The composition according to claim 1, wherein the high-concentration aldehyde-based fixative solution comprises one or more buffers and has a pH in the range of about 6 to about 8.

5. The composition of claim 4, wherein the one or more buffers are selected from Bis-Tris, PIPES, MOPSO, BES, MOPS, HEPES, DIPSO, MOBS, HEPPSO, POPSO, EPPS, Imidazole, Maleate, and Phosphate.

6. The composition of claim 4, wherein the high-concentration aldehyde-based fixative solution comprises a phosphate buffer.

7. The composition of claim 1, wherein the high-concentration aldehyde-based fixative solution has an osmolarity of 300 to 1200 mOsm/L at 25° C.

8. The composition of claim 1, wherein the aldehyde is formaldehyde.

9. The composition of claim 8, wherein the high-concentration aldehyde-based fixative solution is greater than 20% formalin.

10. The composition of claim 8, wherein the high-concentration aldehyde-based fixative solution is greater than 25% formalin.

11. The composition of claim 8, wherein the high-concentration aldehyde-based fixative solution is at least about 30% formalin.

12. The composition of claim 8, wherein the high-concentration aldehyde-based fixative solution is from about 30% formalin to about 50% formalin.

13. The composition of claim 1, wherein the high-concentration aldehyde-based fixative solution does not contain an effective amount of exogenously added nuclease inhibitor, phosphatase inhibitor, kinase inhibitor, or protease inhibitor.

14. The composition according to claim 13, wherein the high-concentration aldehyde-based fixative solution consists of at least about 30% formalin, optionally one or more buffers and sufficient acid or base to obtain a desired pH, optionally one or more stabilizers, and optionally one or more inorganic salts.

15. The composition of claim 1, wherein the composition has a volume ratio of high-concentration aldehyde-based fixative solution to tissue of less than 50:1.

16. A method of fixing a tissue sample, the method comprising immersing the tissue sample in a high-concentration aldehyde-based fixative solution to form a composition according claim 1, wherein the tissue is immersed in the high-concentration aldehyde-based fixative solution for a period of time sufficient to permit the high-concentration aldehyde-based fixative solution to diffuse through the tissue sample, and wherein the temperature of the aldehyde-based fixative is low enough to substantially prevent cross-linking during diffusion.

17. The method of any of claim 16, wherein, after the aldehyde has been allowed to diffuse into the tissue, the temperature is raised for a period of time sufficient to fix the tissue, wherein post-translation modification signals of said tissue sample are preserved.

18. The method of claim 17, wherein:
(a) the tissue sample is immersed in the high-concentration aldehyde fixative solution at a temperature within the range of about −20° C. to about 15° C. for a first time period sufficient to diffuse the solution into the tissue sample; and
(b) the tissue sample is immersed in a standard aldehyde fixative solution at a second temperature within the range of about 22° C. to about 50° C. for a second time period sufficient to preserve post-translation modification signal of said tissue sample.

19. A fixed tissue sample obtained by the method of claim 16.

20. The fixed tissue sample according to claim 19, wherein said fixed tissue sample is embedded in paraffin.
